(19) United States
(12) Patent Application Publication
(10) Pub. No.: US 2011/0096235 A1
(43) Pub. Date: Apr. 28, 2011

(54) PORTABLE ELECTRONIC DEVICE AND CHANNEL-SWITCHING METHOD THEREOF

(75) Inventors: Chiao-Yung Chang, Taipei (TW); Chia-Chen Chao, Taipei (TW); Wen-Kang Chen, Taipei (TW); Ting-Hui Lee, Taipei (TW); Jui-Hsiang Yang, Taipei (TW)

(73) Assignee: AVERMEDIA TECHNOLOGIES, INC., Taipei (TW)

(21) Appl. No.: 12/711,542

(22) Filed: Feb. 24, 2010

(30) Foreign Application Priority Data
Oct. 27, 2009 (TW) 098136372

(51) Int. Cl. H04N 5/50

(52) U.S. Cl. 348/570; 348/731; 348/E05.097

(57) ABSTRACT

A portable electronic device includes a TV module and a touch screen module. The TV module is used for receiving a first TV image signal on a first selected channel. The touch screen module is in communication with the TV module and controlled by the TV module for displaying a program frame corresponding to the first image signal in a full-screen mode. The TV module receives a second TV image signal on a second selected channel in response to a handwriting operation on the touch screen module during the full-screen mode.

### FIELD OF THE INVENTION

The present invention relates to a portable electronic device, and more particularly to a portable electronic device utilizing a handwriting operation or a shaking motion to switch channel. The present invention relates to a channel-switching method for use with the portable electronic device.

### BACKGROUND OF THE INVENTION

Nowadays, many portable electronic devices such as smart phones or mobile internet devices (MIDs) have functions of watching TV programs. Since the screen of the portable electronic device is relatively small, the TV program is usually displayed on the screen in a full screen mode in order to achieve better viewing efficacy.

Generally, for switching a current TV channel to another TV channel, the user should open a graphic operating interface in advance. Since the graphic operating interface needs to be shown on the screen of the portable electronic device, the TV program that is being watched by the user fails to be displayed on the screen in the full screen mode during the channel-switching operation. Moreover, it is difficult to operate the graphic operating interface because it is too small.

### SUMMARY OF THE INVENTION

The present invention provides a portable electronic device and a channel-switching method for use with the portable electronic device. Even a TV program is being watched, the user may switch the TV channel to watch another TV program without the need of opening a graphic operating interface.

In accordance with an aspect of the present invention, there is provided a portable electronic device. The portable electronic device includes a TV module and a touch screen module. The TV module is used for receiving a first TV image signal on a first selected channel. The touch screen module is in communication with the TV module and controlled by the TV module for displaying a program frame corresponding to the first image signal in a full-screen mode. The TV module receives a second TV image signal on a second selected channel in response to a handwriting operation on the touch screen module during the full-screen mode.

In accordance with another aspect of the present invention, there is provided a channel-switching method. Firstly, a first TV image signal on a first selected channel is received. Then, a program frame corresponding to the first image signal is displayed on the touch screen module in a full-screen mode. A second TV image signal on a second selected channel is received in response to a handwriting operation on the touch screen module during the full-screen mode, so that another program frame corresponding to the second image signal is displayed on the touch screen module in the full-screen mode.

In accordance with a further aspect of the present invention, there is provided a portable electronic device. The portable electronic device includes a TV module and a touch screen module. The TV module is used for receiving a first TV image signal on a first selected channel. The touch screen module is in communication with the TV module and controlled by the TV module for displaying a program frame corresponding to the first image signal in a full-screen mode. A channel information is displayed on the touch screen module in response to a handwriting operation on the touch screen module during the full-screen mode.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a functional block diagram illustrating a portable electronic device according to a first embodiment of the present invention;

FIG. 1B is a flowchart illustrating a channel-switching method for use with the portable electronic device of FIG. 1A;

FIGS. 2A, 2B and 2C are schematic diagrams illustrating the steps of performing the channel-switching method of FIG. 1B;

FIG. 3A is a functional block diagram illustrating a portable electronic device according to a second embodiment of the present invention;

FIG. 3B is a flowchart illustrating a channel-switching method for use with the portable electronic device of FIG. 3A;

FIGS. 4A, 4B and 4C are schematic diagrams illustrating the steps of performing the channel-switching method of FIG. 3B; and

FIG. 5 is a functional block diagram illustrating a detailed architecture of the portable electronic device shown in FIG. 3A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

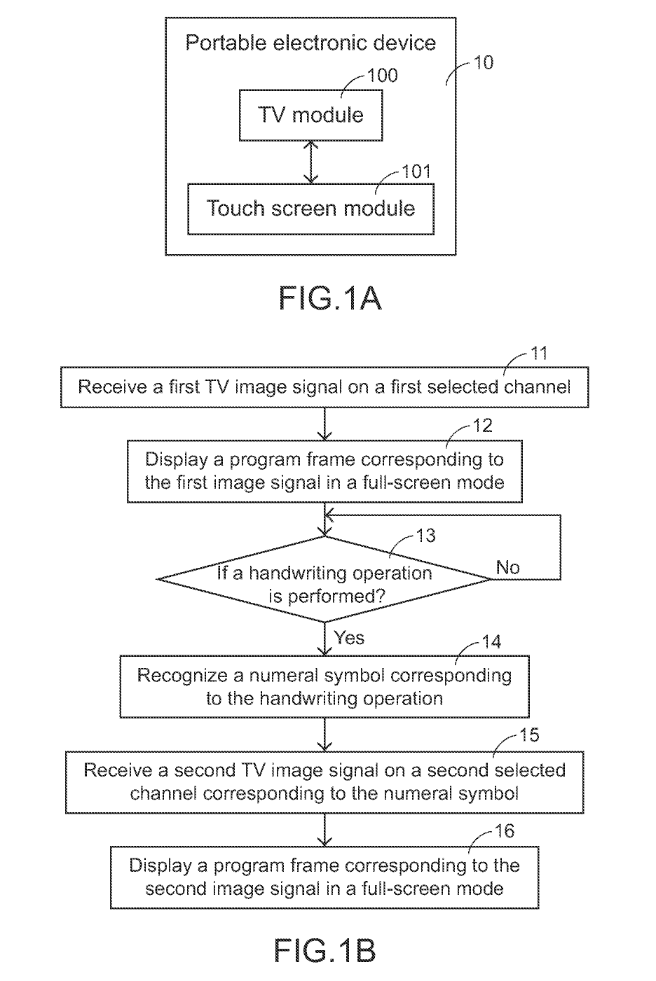

FIG. 1A is a functional block diagram illustrating a portable electronic device according to a first embodiment of the present invention. As shown in FIG. 1A, the portable electronic device 10 comprises a TV module 100 and a touch screen module 101. The TV module 100 is used for receiving a first TV image signal on a first selected channel. The touch screen module 101 is in communication with the TV module 100 and controlled by the TV module 100, so that a program frame corresponding to the first image signal is displayed on the touch screen module 101 in a full-screen mode. Moreover, in response to a handwriting operation, the touch screen module 101 generates a first channel-switching signal to the TV module 100. In response to the first channel-switching signal, the TV module 100 will receive a second TV image signal on a second selected channel.

The steps of switching the channel of the portable electronic device 10 will be illustrated with reference to a flowchart of FIG. 1B. First of all, a first TV image signal is received by the TV module 100 on a first selected channel (Step 11). Then, a program frame corresponding to the first image signal is displayed on the touch screen module 101 in a full-screen mode (Step 12). Then, a step of determining whether a handwriting operation is performed on the touch screen module 101 (Step 13). Once a handwriting operation is performed, a numeral symbol corresponding to the handwriting operation will be recognized (Step 14), and then a second TV image signal is received by the TV module 100 on a second selected channel corresponding to the numeral symbol (Step 15). Afterwards, a program frame corresponding to the second image signal is displayed on the touch screen module 101 in a full-screen mode (Step 16).

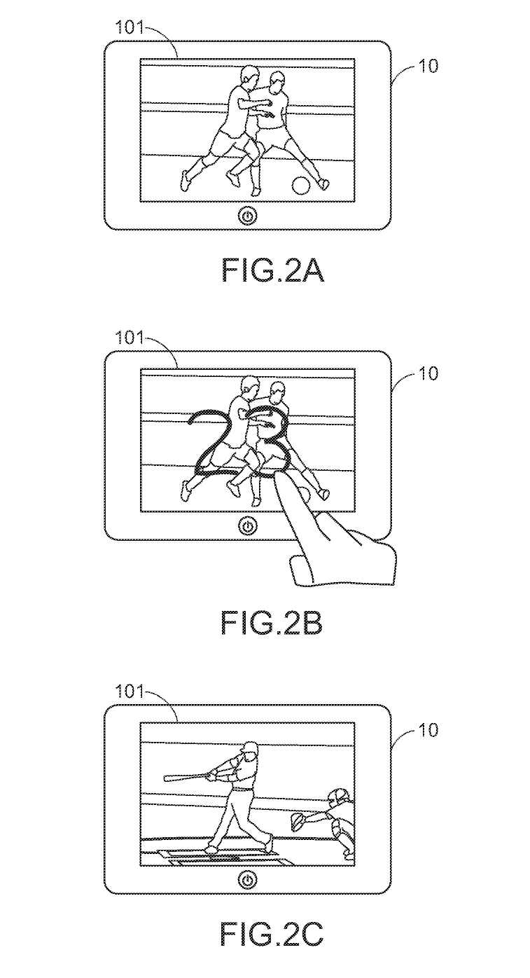

FIGS. 2A, 2B and 2C are schematic diagrams illustrating the steps of performing the channel-switching method according to the first embodiment. As shown in FIG. 2A, a program frame corresponding to a first selected channel is displayed on the touch screen module 101 in a full-screen mode. For switching the first selected channel to a second selected channel (e.g. Channel 23), the user may handwrite the number of the second selected channel (e.g. “23”) on the touch screen module 101 within a specified time interval (e.g. 2 seconds) (see FIG. 2B). After the number of the second selected channel (e.g. “23”) is recognized by the portable electronic device 10, the portable electronic device 10 will switch the first selected channel to the second selected channel (e.g. Channel 23). Meanwhile, a program frame corresponding to the second selected channel is displayed on the touch screen module 101 in a full-screen mode (see FIG. 2C).

When the user is watching a TV program by using the portable electronic device 10, the current channel may be switched to another channel without the need of opening a graphic operating interface. That is, when the number of the second selected channel (e.g. “23”) is handwritten on the touch screen module 101, the user could still watch the TV program of the current channel (e.g. the first selected channel).

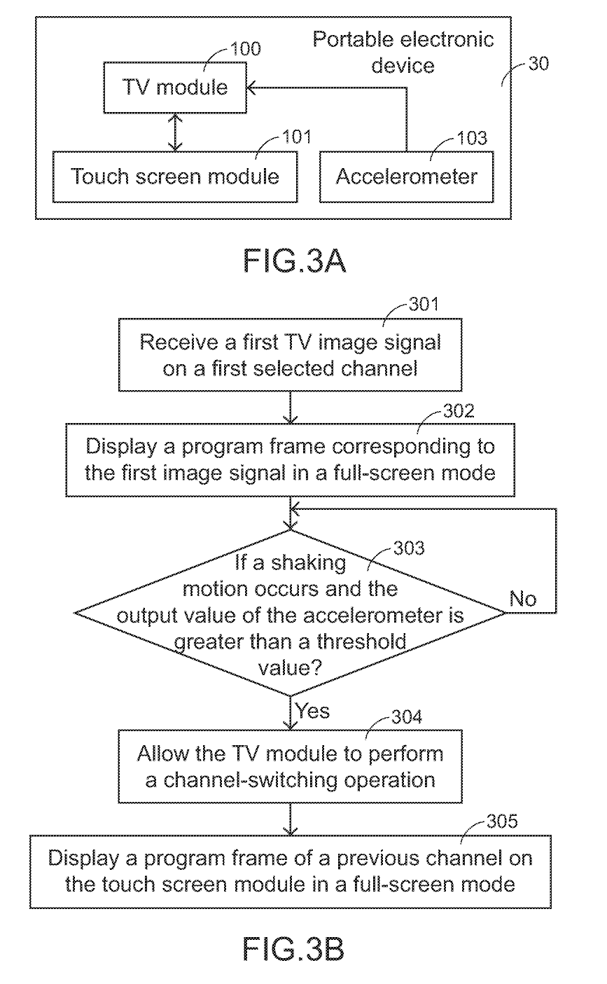

FIG. 3A is a functional block diagram illustrating a portable electronic device according to a second embodiment of the present invention. As shown in FIG. 3A, the portable electronic device 30 comprises a TV module 100, a touch screen module 101 and an accelerometer 103. The operating principles of the TV module 100 and the touch screen module 101 are similar to those illustrated in the first embodiment, and are not redundantly described herein. The accelerometer 103 is used to detect a motion (e.g. a shaking motion) of the portable electronic device 30. In response to the shaking motion, the accelerometer 103 generates a second channel-switching signal to the TV module 100. In response to the second channel-switching signal, the TV module 100 will perform a channel-switching operation.

The steps of switching the channel of the portable electronic device 30 will be illustrated with reference to a flowchart of FIG. 3B. First of all, a first TV image signal is received by the TV module 100 on a first selected channel (Step 301). Then, a program frame corresponding to the first image signal is displayed on the touch screen module 101 in a full-screen mode (Step 302). Then, a step of determining whether a shaking motion occurs and the output value of the accelerometer 103 is greater than a threshold value (Step 303), thereby preventing from erroneous determination. If the output value of the accelerometer 103 is greater than the threshold value, the TV module 100 will perform a channel-switching operation (Step 304). Afterwards, a program frame of the previous selected channel is displayed on the touch screen module 101 in a full-screen mode (Step 305).

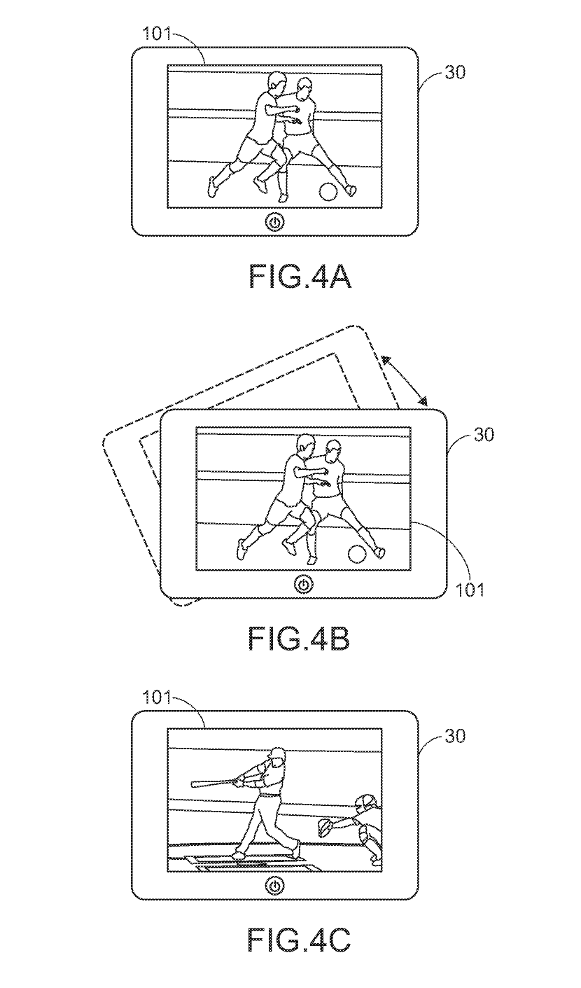

FIGS. 4A, 4B and 4C are schematic diagrams illustrating the steps of performing the channel-switching method according to the second embodiment. As shown in FIG. 4A, a program frame corresponding to a specified channel is displayed on the touch screen module 101 in a full-screen mode. For recalling the TV program of the previous selected channel, the user may shake the portable electronic device 30 (see FIG. 4B). If the shaking motion of the portable electronic device 30 is effectively detected and the output value of the accelerometer 103 is greater than the threshold value, the program frame corresponding to the previous selected channel will be displayed on the touch screen module 101 in a full-screen mode (see FIG. 4C).

When the user is watching a TV program by using the portable electronic device 30, the current channel may be switched to the previous channel without the need of opening a graphic operating interface. That is, during the operation of shaking the portable electronic device 30, the user could still watch the TV program of the current channel. In an embodiment, the shaking motion may correspond to a channel up or channel down operation. Different shaking directions may correspond to different channel-switching directions, and the shaking direction can be detected by the accelerometer 103. It is to be noted that the method is applicable to other possible operations, but not limited to recalling previous selected channel.

In the above embodiments, the portable electronic device 10 or 30 is a smart phone, a tablet PC, a personal digital assistant (PDA), a mobile internet device (MID), or the like. The touch screen module 101 included in the portable electronic device 10 or 30 is used for inputting and displaying purposes. The TV module 100 included in the portable electronic device 10 or 30 is used for receiving TV image signals. The TV image signals are wireless or cable signals in an analog or digital format, and can be displayed on the touch screen module 101.

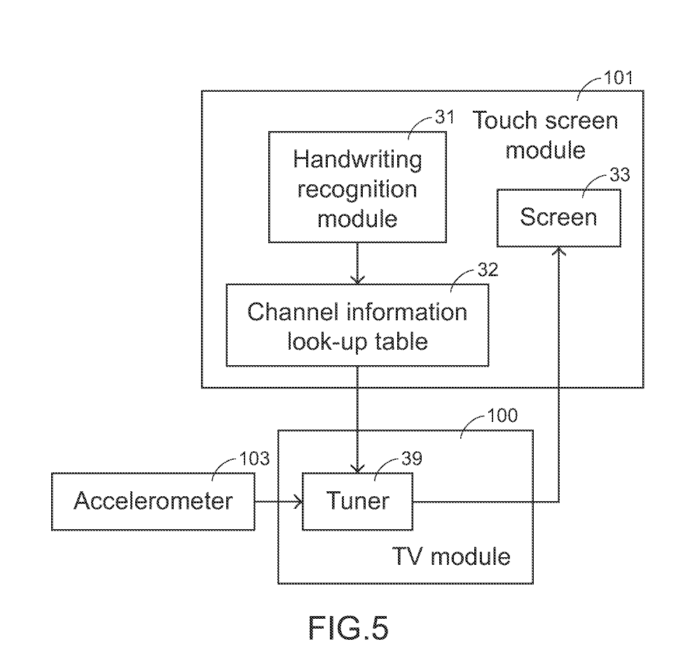

FIG. 5 is a functional block diagram illustrating a detailed architecture of the portable electronic device shown in FIG. 3A. As shown in FIG. 3, the portable electronic device 30 comprises a screen 33, a handwriting recognition module 31, a channel information look-up table 32, a tuner 39, and an accelerometer 103. The screen 33, the handwriting recognition module 31 and the channel information look-up table 32 are included in the touch screen module 101. In addition, the handwriting recognition module 31 is integrated into a surface of the screen 33. In a case that a channel number (e.g. “23”) is handwritten on the surface of the screen 33, the number “23” will be recognized by the handwriting recognition module 31, and a frequency corresponding to the channel number will be realized from the channel information look-up table 32. According to the frequency, the handwriting recognition module 31 generates a first channel-switching signal to the tuner 39 of the TV module 100. In response to the first channel-switching signal, the tuner 39 of the TV module 100 will receive the TV image signal on the Channel 23. Afterwards, the TV image signal is displayed on the screen 33.

In a case that the information of an electronic program guide (EPG) is included in the channel information look-up table 32, the user may handwrite the channel name (e.g. “ESPN”) on the touch screen module 101. After the channel name is recognized, a frequency corresponding to the channel name (e.g. “ESPN”) will be realized from the channel information look-up table 32. According to the frequency, the tuner 39 of the TV module 100 switches the current channel to the Channel ESPN. In addition, the user may handwrite a keyword (e.g. “sport”) on the touch screen module 101, the channel names and channel numbers associated with the keyword (e.g. ESPN, TNT, . . . ) will be acquired from the channel information look-up table 32 according to the information of the electronic program guide. In addition, if the user handwrites a keyword “news” on the touch screen module 101, associated channel information (e.g. CNN, BBC, . . . ) will be listed for selection.

During the channel switching operation of the portable electronic device 30, if the handwritten channel number fails to be recognized by the handwriting recognition module 31 within a specified time interval (e.g. 2 seconds), the handwriting operation is deemed as an invalid action. Meanwhile, the TV program of the original channel is continuously displayed on the screen 33. For example, if it takes a long time period (e.g. more than 2 seconds) or the channel number is blurred to be recognized by the handwriting recognition module 31 within the specified time interval, the handwriting operation is deemed as an invalid action.

Moreover, if the handwritten number of the second selected channel (e.g. “203”) is not included in a channel selection menu, the information associated with Channel 203 is not contained in channel information look-up table 32 and thus the handwriting operation is also deemed as an invalid action. Meanwhile, the TV program of the original channel is continuously displayed on the screen 33.

From the above description, the portable electronic device and the channel-switching method of the present invention are more user-friendly and convenient for switching a TV channel. Therefore, the drawbacks encountered from the prior art are overcome.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable electronic device, comprising:
a TV module for receiving a first TV image signal on a first selected channel; and
a touch screen module in communication with the TV module and controlled by the TV module for displaying a program frame corresponding to the first image signal in a full-screen mode, wherein the TV module receives a second TV image signal on a second selected channel in response to a handwriting operation on the touch screen module during the full-screen mode.

2. The portable electronic device according to claim 1, further comprising an accelerometer in communication with the TV module for detecting a shaking motion, wherein the TV module performs a channel-switching operation in response to the shaking motion.

3. The portable electronic device according to claim 2 wherein if the shaking motion is detected by the accelerometer and the accelerometer has an output value greater than a threshold value, the TV module performs the channel-switching operation.

4. The portable electronic device according to claim 3 wherein when the channel-switching operation is performed, a current selected channel is switched to a previous selected channel.

5. The portable electronic device according to claim 1 wherein the channel-switching operation is performed by handwriting a numeral symbol on the touch screen module, wherein if the numeral symbol is recognized by the touch screen module, the touch screen module generates a channel-switching signal to the TV module, and the TV module receives the second TV image signal on the second selected channel in response to the channel-switching signal.

6. The portable electronic device according to claim 5 wherein the touch screen module determines not to generate the channel-switching signal if the number symbol fails to be recognized by the touch screen module within a specified time interval.

7. The portable electronic device according to claim 5 wherein the touch screen module determines not to generate the channel-switching signal if the numeral symbol recognized by the touch screen module is not included in a channel selection menu.

8. A channel-switching method for use with a portable electronic device having a touch screen module, the channel-switching method comprising steps of:
receiving a first TV image signal on a first selected channel;
displaying a program frame corresponding to the first image signal on the touch screen module in a full-screen mode; and
receiving a second TV image signal on a second selected channel in response to a handwriting operation on the touch screen module during the full-screen mode, so that another program frame corresponding to the second image signal is displayed on the touch screen module in the full-screen mode.

9. The channel-switching method according to claim 8 wherein a channel-switching operation is performed in response to a shaking motion of the portable electronic device.

10. The channel-switching method according to claim 9 wherein when the channel-switching operation is performed, a current selected channel is switched to a previous selected channel.

11. The channel-switching method according to claim 8 wherein the channel-switching operation is performed by handwriting a numeral symbol on the touch screen module, wherein if the numeral symbol is recognized by the touch screen module, the touch screen module generates a channel-switching signal to the TV module, and the TV module receives the second TV image signal on the second selected channel in response to the first channel-switching signal.

12. The channel-switching method according to claim 11 wherein the channel-switching signal is not generated by the touch screen module if the number symbol fails to be recognized by the touch screen module within a specified time interval.

13. The channel-switching method according to claim 11 wherein the channel-switching signal is not generated by the touch screen module if the numeral symbol recognized by the touch screen module is not included in a channel selection menu.

14. A portable electronic device, comprising:
a TV module for receiving a first TV image signal on a first selected channel; and
a touch screen module in communication with the TV module and controlled by the TV module for displaying a program frame corresponding to the first image signal in a full-screen mode, wherein a channel information is displayed on the touch screen module in response to a handwriting operation on the touch screen module during the full-screen mode.
